(19) United States
(12) Patent Application Publication
(10) Pub. No.: US 2013/0064627 A1
(43) Pub. Date: Mar. 14, 2013

(54) EXPANDABLE MEMBER AND METHOD OF MAKING THE SAME

(71) Applicant: Richard M. Beeler, Saxonburg, PA (US)

(72) Inventor: Richard M. Beeler, Saxonburg, PA (US)

(73) Assignee: ALCOA INC., Pittsburgh, PA (US)

(21) Appl. No.: 13/609,809

(22) Filed: Sep. 11, 2012

Related U.S. Application Data
(60) Provisional application No. 61/533,316, filed on Sep. 12, 2011.

(51) Int. Cl. F01B 29/10; B32B 1/06; B21D 51/26

(52) U.S. Cl. 413/1; 60/527; 428/71

(57) ABSTRACT

The instant disclosure provides an apparatus, comprising a metallic body having at least one sidewall, wherein the sidewall encloses a void, and an expandable material retained within the void and encased by the sidewall; wherein the void comprises a first volume at a first temperature; and wherein, at a second temperature of at least about 500° C., the expandable material expands such that the void comprises a second volume, wherein the second volume is greater than the first volume, wherein, via the expansion of the expandable materials, the at least one sidewall exerts a pressure of at least about 150 psig. Methods are also provided.

### CROSS-REFERENCE TO RELATED APPLICATIONS

This application claims priority to U.S. Application Ser. No. 61/533,316, entitled “Expandable Member and Method of Making the Same” filed on Sep. 12, 2011, which is incorporated by reference in its entirety.

### BACKGROUND

Systems often have multiple components that contact one another (electrically and/or mechanically) in order for the system to work effectively and efficiently. Many systems include system components of differing materials, so these materials have different chemical and physical properties.

### SUMMARY OF THE DISCLOSURE

Systems that have components of different materials that operate at high temperatures (e.g. at least about 500° C.) experience different rates of thermal expansion and/or different rates of creep in the different system components. This can cause gaps between system components, resulting in reduced mechanical contact and/or increased electrical resistance between system components. System components may “spread out” from one another over continued system operation, or over a large number of system runs. Various aspects of the instant disclosure use an expandable member (e.g. metallic body) to apply a compressive force to one or more system components (e.g. adjacent objects) at elevated temperatures to increase the conformity (e.g. mechanical connection, electrical contact) between the system components.

Broadly, the present disclosure relates to utilizing an expandable member that expands at elevated temperature to apply a force to one or more surrounding components. Thus, for high temperature applications to (e.g. above 500° C.) the expandable member exerts a force on one or more components in a system in order to maintain or improve the contact (e.g. physical contact, electrical connection) between various components.

Joint resistance in the systems may be attributed to one or more mechanisms and/or sources. Some non-limiting examples of sources of joint resistance in the systems include: creep, phase change, spacer standoff, voids, non-conforming surfaces, and combinations thereof. In various embodiments, voids, phase changes, and creep occur respectively before, during, and after the startup of a system (e.g. operating at high temperatures). In some embodiments, a resulting surface non-conformity between the system components develops in each of these phases. The instant disclosure prevents, reduces and/or eliminates joint resistivity (i.e. high electrical resistance) and/or mechanical gaps by utilizing an expandable member (also called a metallic body) compression device to apply stress to the components of the system thus conforming the system components. In some embodiments, applying stress to the system components while the system assembly is cold, during start up, or at operating conditions (e.g. high temperature and pressure) improves the joint during operation of the system at operating conditions (e.g. elevated temperatures of at least about 500° C.).

In one or more of these embodiments, the expandable member imparts a continuous amount of force on the end(s) of the adjacent objects. In one or more embodiments, the expandable member imparts a variable amount of force on the end(s) of the adjacent objects (e.g. based on a feedback loop).

In one aspect, an expandable member (sometimes referred to as an expandable balloon or a metallic body) is provided.

In one embodiment, an apparatus is provided. In one embodiment apparatus comprises: a metallic body having at least one sidewall, wherein the sidewall encloses a void, and an expandable material retained within the void and encased by the sidewall; wherein the void comprises a first volume at a first temperature; and wherein, at a second temperature of at least about 900° C., the expandable material expands such that the void comprises a second volume, wherein the second volume is greater than the first volume, wherein, via the expansion of the expandable materials, the at least one sidewall exerts a pressure of at least about 150 psig.

In one embodiment, the metallic body is sealed (e.g. with a seam or mechanically fastened portion). In some embodiments, the metallic body is sealed by a sealant selected from the group consisting of: mechanical fasteners, bolts, welds, rivets, adhesives, and combinations thereof.

In one embodiment, the expandable material comprises a gas; an inert gas, a phase change material (e.g. solid, expandable material), and combinations thereof.

In one embodiment, the gas comprises an inert gas (e.g. argon), oxygen, carbon dioxide, nitrogen, or combinations thereof.

In one embodiment, the void (sometimes called a central region) further comprises: a filler material (e.g. which does not expand or undergo a phase change). As some non-limiting examples, the filler material is selected from the group consisting of: ceramic materials, aggregate, tabular alumina, refractory materials, rocks, graphite, and combinations thereof.

In one embodiment, the filler material comprises at least about 50% of first volume the void.

In one embodiment, the at least one sidewall is not greater than about one inch thick,

In one embodiment, the void is centrally located in the metallic body.

In one embodiment, the cross-sectional area ratio of the sidewall to the void is about 1:10.

In one embodiment, the metallic body comprises two sidewalls having opposing planar faces and a rounded perimetrical edge connecting the two faces.

In one embodiment, the void is pressurized at a first temperature of not greater than about 100 psig (e.g. pre-pressurized above 1 ATM).

In one embodiment, the metallic body comprises an internal pressure of at least about 1.5 ATM at the second temperature.

In another aspect of the invention, a method is provided. The method comprises: increasing the temperature of a metallic body from a first temperature to a second temperature of at least about 500° C., wherein the metallic body comprises: at least one sidewall, wherein ₜhe sidewall encloses a central region having an expandable material retained therein via the sidewall; concomitant with the increasing temperature step, increasing the volume of the central region via the expansion of the expandable material at the second temperature; exerting, via the sidewall of the metallic body, a pressure of at least about 100 psig onto an adjacent object, wherein the adjacent object is in communication with the sidewall.

In one embodiment, the method comprises: moving the object first position to a second position,

In one embodiment, the step of increasing the temperature step further comprises heating the adjacent object.

In one embodiment, the method comprises compressively straining the adjacent object.

In yet another aspect of the invention, a method is provided. The method comprises: forming at least one sidewall around an inner void to provide a metallic body having an opening; inserting an expandable material into the void via the opening (e.g. pre-pressurized void with gas); closing the metallic body, thus completely enclosing the void having an expandable material therein.

In one embodiment, the expandable member includes: a plurality of walls comprising a metal material; and at least one seal along the plurality of walls to define a shell (body) having at least two faces; and an inner void completely encased within the shell, wherein the inner void includes at least one of: a gas, an expandable material, an inert material, and combinations thereof; wherein the shell expands at elevated temperatures (exceeding ambient temperatures) such that the inner void comprises a pressure above ambient (e.g. at least about 1.5 ATM).

In one embodiment, the expandable member is solid, yet capable of expansion. In some embodiments, the expandable member is composed of metal (e.g. a metallic material). Some non-limiting example metals include: carbon steel, stainless steel, graphite, Inconnel, and/or steel. In one embodiment, the balloon includes at least one wall that seals in an inner void. In one embodiment, the balloon includes a plurality of walls (e.g. 2, 4, or more) that enclose and seal in an inner void.

In one embodiment, the expandable member (sometimes referred to as, e.g. an expandable balloon metallic body) is a ferritic/magnetic stainless steel, including as non-limiting examples 304SS, 304L, 430, 410, and 409.

In some embodiments, the improved contact at the interface of the system components is measureable, correlated, and/or quantified by one or more characteristics. As non-limiting examples, the compression device causes a decrease in electrical resistance, an increase in surface area (between the system components and/or expandable member, a dimensional change in the system components (e.g. the amount that extends from the system/equipment configuration), and combinations thereof.

In various embodiments, the balloon is of different shapes, including rectangular, oval, circular, polygonal and the like. As some non-limiting examples, the dimension of the balloon includes: a rectangular shape, a square shape, a polygonal shape, an oval shape, and/or a rounded shape.

In some embodiments, the wall thickness varies. In some embodiments, the wall is: at least about 1/16″ thick; least about ⅛″ thick; at least about ¼″ thick, at least about ½″ thick, at least about ¾″ thick, at least about 1″ thick; at least about 1.5′ thick; or at least about 2″ thick.

In some embodiments, the wall is: not greater than about 1/16″ thick not greater than about ⅛″ thick; not greater than about ¼″ thick, not greater than about ½″ thick, not greater than about ¾″ thick, not greater than about 1″ thick; not greater than about 1.5″ thick, or not greater than about 2″ thick.

In some embodiments, the inner void is filled with air (e.g. of atmospheric composition), a gas (e.g. pure or mixed composition), an inert material (e.g. non-reactive at elevated temperatures (e.g. below 100° C.) and/or pressures), an expandable material, or combinations thereof.

As used herein, expandable material refers to a material that expands or enlarges under different conditions. As non-limiting examples, the expansion of the expandable material is attributable to phase change, decomposition, and/or density change upon different temperature or pressure conditions. In one non-limiting example, the expandable material expands inside the balloon at increased temperature. As another example, at the increased temperature, the expandable material undergoes a phase change (i.e. solid to gas) to increase volume at the increased temperature.

Non-limiting examples of expandable materials include any chemical that degrades (or decomposes) at elevated temperatures, for example, temperatures above room temperature (e.g. about 20-25 C). In one embodiment, expandable materials degrade at temperatures above the temperature at which the balloon was formed (i.e. but before the system is at operating temperature). In one embodiment, the expandable material degrades at temperatures exceeding about 800° C. (e.g. operating temperature, or 900° C.-930° C.). Other non-limiting examples of expandable materials include: MgCO₃ (decomposes at 350 C); CaCO₃ (Calcite, decomposes at 898° C.), or CaCO₃ (aragonite, decomposes at 825° C., where each of these materials releases carbon dioxide gas at elevated temperatures. In some embodiments, the expandable material includes one or more materials that boil, sublime, or decompose into gas between room temperature and 900° C. (e.g. undergo a phase change).

In some embodiments, at elevated temperature and pressure conditions inside the expandable member, the gas and/or expandable material inside the balloon expand to push the metallic walls outward (e.g. solid, non-permeable metal walls). In some embodiments, the pressure inside the expandable member deforms the profile of the walls such that the walls bow outward. In some embodiments, the rise from ambient temperature to elevated temperatures (e.g. 900° C.-930° C.) increases the internal absolute pressure by a factor of 4 inside the balloon.

In another embodiment, the cavity/void inside the balloon is pressurized before operation. In one embodiment, with the appropriate formation conditions and sealing operations, the internal conditions of the expandable member are pre-pressurized. As some non-limiting examples, the pressure is at least about atmospheric pressure, at least about 1.5 ATM; at least about 2 ATM, at least about 3 ATM, at least about 4 ATM, or at least about 5 ATM. As some non-limiting examples, the pressure is at least about atmospheric pressure, at least about 1 ATM; at least about 2 ATM, at least about 5 ATM, at least about 10 ATM, at least about 15 ATM, or at least about 20 ATM. As some non-limiting examples, the pressure is not greater than about atmospheric pressure, not greater than about 1.5 ATM; not greater than about 2 ATM, not greater than about 3 ATM, not greater than about 4 ATM, or not greater than about 5 ATM. As some non-limiting examples, the pressure is not greater than about atmospheric pressure, not greater than about 1 ATM; not greater than about 2 ATM, not greater than about 5 ATM, not greater than about 10 ATM, not greater than about 15 ATM, or not greater than about 20 ATM.

In one embodiment, the metallic body (expandable balloon) is pre-pressurized: to at least about 5 psig; to at least about 10 psig; to at least about 15 psig; to at least about 20 psig; to at least about 25 psig; to at least about 30 psig; to at least about 35 psig; to at least about 40 psig; to at least about 45 psig; to at least about 50 psig; to at least about 55 psig; to at least about 60 psig; to at least about 65 psig; to at least about 70 psig; to at least about 75 psig; to at least about 80 psig; to at least about 85 psig; to at least about 90 psig; or at least about 100 psig.

In one embodiment, the expandable balloon (metallic body) is pre-pressurized: to not greater than about 5 psig; to not greater than about 10 psig; to not greater than about 15 psig; to not greater than about 20 psig; to not greater than about 25 psig; to not greater than about 30 psig; to not greater than about 35 psig; to not greater than about 40 psig; to not greater than about 45 psig; to not greater than about 50 psig; to not greater than about 55 psig; to not greater than about 60 psig; to not greater than about 65 psig; to not greater than about 70 psig; to not greater than about 75 psig; to not greater than about 80 psig; to not greater than about 85 psig; to not greater than about 90 psig; or not greater than about 100 psig.

In another embodiment, a small amount of material is sealed inside the balloon, where the material adds to the pressure as it heats up (e.g. by a phase change) to gas, and/or by decomposition that emits gas. For example MgCO₃ releases CO₂ gas near 350° C.

In some embodiments, the balloon is used with fillers (e.g. filler material) between the balloon sides and/or the inner ends of the adjacent objects, Fillers are generally selected from solid materials that maintain stiffness (e.g. rigidity) at elevated temperature. Non-limiting examples of fillers include tabular alumina, copper, ceramic materials, refractory materials, aggregate, and the like. In some embodiments, the balloons are welded closed, though other methods of sealing the balloons may be employed.

In another embodiment, a filler material (which is inert) is used inside the expandable member. In one embodiment, the inert material is porous and/or particulate. As a non-limiting example, the inert material includes tabular alumina, gravel, aggregate, ceramic materials, refractory materials, and the like, which fills a portion of, or the entirety of, the cavity. By utilizing an inert material, the size of the cavity could be large, while the amount of gas providing the pressure (i.e. the volume that is not occupied by inert material) would be small. With such an embodiment, it is possible to limit creep in the expandable member, (which would slow as the cavity expanded and pressure dropped). Also, with such an embodiment, the amount of gas that could potentially erupt from the expandable member during the operation at higher temperatures is limited.

In some embodiments, the resulting, improved contact at the interface comprises a common surface area sufficient to reduce a measured voltage drop (e.g. across the two electrically connected system components) by: at least about 10 mV; at least about 20 mV; at least about 30 mV; at least about 40 mV; at least about 50 mV; at least about 60 mV; at least about 70 mV; at least about 80 mV; at least about 90 mV; 100 mV; at least about 120 mV; at least about 140 mV; or at least about 160 mV.

In some embodiments, the resulting, improved contact at the interface comprises a common surface area sufficient to reduce a measured voltage drop (e.g. across the two electrically connected system components) by: not greater than about 10 mV; not greater than about 20 mV; not greater than about 30 mV; not greater than about 40 mV; not greater than about 50 mV; not greater than about 60 mV; not greater than about 70 mV; not greater than about 80 mV; not greater than about 90 mV; 100 mV; not greater than about 120 mV; not greater than about 140 mV; or not greater than about 160 mV.

In sonic embodiments, the electrical resistance at the joint of two system components is reduced by a factor of at least about 3; at least about 5; at least about 10; at least about 20; at least about 40; at least about 60; at least about 80; or at least about 100.

In some embodiments, the electrical resistance at the joint of two system components is reduced by a factor of: not greater than about 3; not greater than about 5; not greater than about 10; not greater than about 20; not greater than about 40; not greater than about 60; not greater than about 80; or not greater than about 100.

In some embodiments, the expandable member increases the amount of contact (or common surface area) between system components by: at least about 2%; at least about 4%; at least about 6%; at least about 8%; at least about 10%; at least about 15%; at least about 20%; at least about 40%; at least about 50%; at least about 75%; or at least about 100% (e.g. when no contact existed before the expandable member was in place/operating on the end of the system component.

In some embodiments, the expandable member increases the amount of contact (or common surface area of system components) by: not greater than about 2%; not greater than about 4%; not greater than about 6%; not greater than about 8%; not greater than about 10%; not greater than about 15%; not greater than about 20%; not greater than about 40%; not greater than about 50%; not greater than about 75%; or not greater than about 100% (e.g. when no contact existed before the expandable member was in place/operating on the end of the system component.

In another aspect, a method of making an expandable member is provided. The method comprises: aligning a plurality of (at least two) metallic walls to provide a void therein; and sealing the plurality of walls.

In one embodiment, the expandable member is cast from a mold. In one embodiment, the expandable member is extruded to form. In one embodiment, the expandable member is machined. In one embodiment, the expandable member portions are adhered together. In one embodiment, the expandable member is welded together. In one embodiment, the expandable member is screwed together. In one embodiment, the expandable member is bolted together. In one embodiment, the expandable member is mechanically fastened together.

In one embodiment, the method comprises inserting a material (e.g. gas, expandable material, inert material) into the void (sometimes called an inner void or central region).

In some non-limiting embodiments, sealing includes welding, mechanically fastening, adhering, riveting, bolting, screwing, and the like.

In one embodiment, the method comprises: expanding the walls of the expandable member at temperatures exceeding at least about 100° C.

In one embodiment, the method comprises: increasing the pressure in the inner void at temperatures exceeding at least about 100° C.

In another aspect, a method is provided. The method comprises: providing an expandable member having walls and a gaseous inner void; increasing the temperature of the expandable balloon to expand the inner void, wherein due to the expansion of the inner void, the walls of the expandable member deform in an outward direction; and applying a compressive force to at least one component (sometimes called a surrounding component or adjacent object), which is external to the expandable balloon (i.e. adjacent and/or in communication with the at least one sidewall of the metallic body/expandable balloon).

In some embodiments, the method comprises exerting pressure onto a surrounding component of at least about 10 PSIG; at least about 20 PSIG; at least about 30 PSIG; at least about 40 PSIG; at least about 50 PSIG; at least about 60 PSIG; at least about 70 PSIG; at least about 80 PSIG; at least about 80 MG; at least about 90 PSIG: at least about 100 PSIG; at least about 110 PSIG; at least about 120 PSIG; at least about 130 PSIG; at least about 140 PSIG; or at least about 150 PSIG.

In some embodiments, the method comprises exerting pressure onto a surrounding component of not greater than about 10 PSIG; not greater than about 20 PSIG; not greater than about 30 PSIG; not greater than about 40 PSIG; not greater than about 50 PSIG; not greater than about 60 PSIG; not greater than about 70 MG; not greater than about 80 PSIG; not greater than about 80 PSIG; not greater than about 90 PSIG: not greater than about 100 PSIG; not greater than about 110 PSIG; not greater than about 120 MG; not greater than about 130 PSIG; not greater than about 140 PSIG; or not greater than about 150 PSIG.

In some embodiments, the compression device imparts a resulting strain on the adjacent object(s) in a transverse direction of: at least about −0.01%; at least about −0.02%; at least about −0.03%; at least about −0.04%; at least about −0.05%; at least about −0.06%; at least about −0.07%; at least about −0.08%; at least about −0.09%; at least about −0.1%. In some embodiments, the compression device imparts a strain on the adjacent object(s) in the transverse direction of: at least about −0.1%; at least about −0.15%; at least about −0.2%; at least about −0.25%; at least about −0.3%; at least about −0.35%; at least about −0.4%; at least about −0.45%; at least about −0,5%; at least about −0.55%; at least about −0.6%; at least about −0.65%; at least about −0.7%; at least about −0.75%; at least about −0.8%; at least about −0.85%; at least about −0.9%; at least about −0.95%; or at least about −1%.

In some embodiments, the compression device imparts a resulting strain on the adjacent object(s) in a transverse direction of: not greater than about −0.01%; not greater than about −0.02%; not greater than about −0.03%; not greater than about −0.04%; not greater than about −0.05%; not greater than about −0.06%; not greater than about −0.07%; not greater than about −0.08%; not greater than about −0.09%; not greater than about −0.1%. In some embodiments, the compression device imparts a strain on the adjacent object(s) in the transverse direction of: not greater than about −0.1%; not greater than about −0.15%; not greater than about −0.2%; not greater than about −0.25%; not greater than about −0.3%; not greater than about −0.35%; not greater than about −0.4%; not greater than about −0.45%; not greater than about −0.5%; not greater than about −0,55%; not greater than about −0.6%; not greater than about −0.65%; not greater than about −0.7%; not greater than about −0.75%; not greater than about −0.8%; not greater than about −0.85%; not greater than about −0.9%; not greater than about −0.95%; or not greater than about −1%.

In some embodiments, the temperature (second temperature) is: at least about 500° C.; at least about 550° C.; at least about 600° C.; at least about 650° C.; at least about 700° C.; at least about 750° C.; at least about 800° C.; at least about 850° C.; at least about 900° C.; at least about 950° C.; at least about 1000° C.; at least about 1050° C.; at least about 1100° C.; at least about 1550° C.; at least about 1200° C.; at least about 1250° C.; or at least about 1300° C. In some embodiments, the temperature (second temperature) is: not greater than about 500° C.; not greater than about 550° C.; not greater than about 600° C.; not greater than about 650° C.; not greater than about 700° C.; not greater than about 750° C.; not greater than about 800° C.; not greater than about 850° C.; not greater than about 900° C.; not greater than about 950° C.; not greater than about 1000° C.; not greater than about 1050° C.; not greater than about 1100° C.; not greater than about 1550° C.; not greater than about 1200° C.; not greater than about 1250° C.; or not greater than about 1300° C. In some embodiments, the first temperature is ambient conditions (e.g. room temperature around 20-25° C.), up to a temperature below 500C (e.g. 400° C., 450° C.).

In some embodiments, the amount of force applied by the expandable member to the other component(s) is large enough and/or over a long enough duration of time to prevent, reduce, and/or eliminate gaps (poor contact) between various components in a system (e.g. a closed system or between two or more components in communication with one another). By eliminating, reducing, and/or preventing the gap, the expandable member may increase efficiency of a system (e.g. a closed system).

In one embodiment, the expandable member is retrofitted onto existing systems. In one embodiment, the expandable member is a component or part of the system, Optionally, the expandable member is manufactured integral with or as an attachable/detachable component with the system/system components and/or the electrical connections of the system.

In one embodiment, the expandable member is configured to transversely expand the other component(s) via the application of an axial force to the other components. For example, the transverse expansion is in a direction generally perpendicular to the direction of the axial force, The transverse expansion of the other component conforms the elements of a system (e.g. closed system) in a desired manner, e.g. to increase physical contact, electrical conductivity, or the like,

In some embodiments, fillers are used in combination with components and the expandable members to provide, for example, a particulate substrate for the expandable member to compress upon. In some embodiments, filler materials are generally selected from solid materials that maintain stiffness (e.g. rigidity) at elevated temperature. Non-limiting examples of fillers include tabular alumina, copper, refractory block, ceramics, aggregate, and the like. In some embodiments, the balloons are welded closed, though other methods of sealing the balloons may be employed.

In one embodiment, the compression device includes a compression detector. The compression detector is located between the component and the compression device and the compression detector is configured to measure the force imparted on the component. In one embodiment, the compression detector measures the expansion of the compression device (e.g. the amount of transverse expansion of the device.) In some embodiments, the compression detector measurements feed into an operating system (not shown) for example, as a real-time feedback loop to vary the amount of compression.

In one embodiment, the method includes: conforming the system components reduce the voltage drop by about 10 mV to about 100 mV. In one embodiment, the method includes: transversely expanding the system component, via the imparting force by the expandable member, to maintain and/or improve the electrical contact between the system components. In some embodiments, the resulting electrical resistance between the system components is less than an initial electrical resistance (i.e. as measured without force from the expandable member). In one embodiment, the method includes adjusting the imparted force to increase, decrease, or maintain the compression of the system components at variable or continuous maintained conditions. In one embodiment, the method includes determining the force imparted on the system components (via a sensor/feedback loop).

These and other aspects, advantages, and novel features of the invention are set forth in part in the description that follows and will become apparent to those skilled in the art upon examination of the following description and Figures, or is learned by practicing the invention.

### BRIEF DESCRIPTION OF THE DRAWINGS

FIG. 1A-1B depict an expandable member having a gaseous void before expansion and after expansion (1A) and a gas +expandable material before and after expansion 1B).

FIGS. 2A-2C depict different embodiments of a compression device on similar components. FIG. 2A depicts a balloon having solid material on either sides of the balloon. FIG. 2B depicts multiple balloons (three) adjacent to one another to extend along the gap between similar. components. FIG. 2C depicts multiple compression device/balloons that are spaced with solid material between the component ends and the multiple balloons between the gap.

FIG. 3 depicts the differences in thermal expansion of different expandable member materials and/or adjacent component materials, plotted as expansion (%) vs. Temperature (C).

FIG. 4A depicts two compression devices, as expandable members, while FIG. 4B depicts the expandable balloons in an expanded state, with walls expanded in an outward direction.

FIG. 5 depicts an exemplary cutaway side view of the expandable balloons used for the trial depicted in FIG. 6.

FIG. 6 depicts the trial run of two expandable balloons, depicting the Pressure (PSIG) as a function of Time (Days).

FIG. 7 depicts a plan side view of an expandable member of a second trial run.

FIG. 8 depicts the resulting pressure (PSIG) and Temperature (C) as a function of Time (days).

FIG. 9 depicts the components of an experiment, including the balloon and adjacent objects (frame and metal bar/block component) prior to assembly into the tested configuration.

FIG. 10 depicts the assembled configuration of the experiment, before the test.

FIG. 11 depicts the assembled configuration for experiment, after the test.

FIG. 12 is a graphical representation of pressure and temperature vs. time (in days) for the experiment.

Various ones of the inventive aspects noted herein above may be combined to yield systems and methods of operating the same.

These and other aspects, advantages, and novel features of the invention are set forth in part in the description that follows and will become apparent to those skilled in the art upon examination of the following description and figures, or may be learned by practicing the invention,

### DETAILED DESCRIPTION

Reference will now be made in detail to the accompanying drawings, which at least assist in illustrating various pertinent embodiments of the instant disclosure.

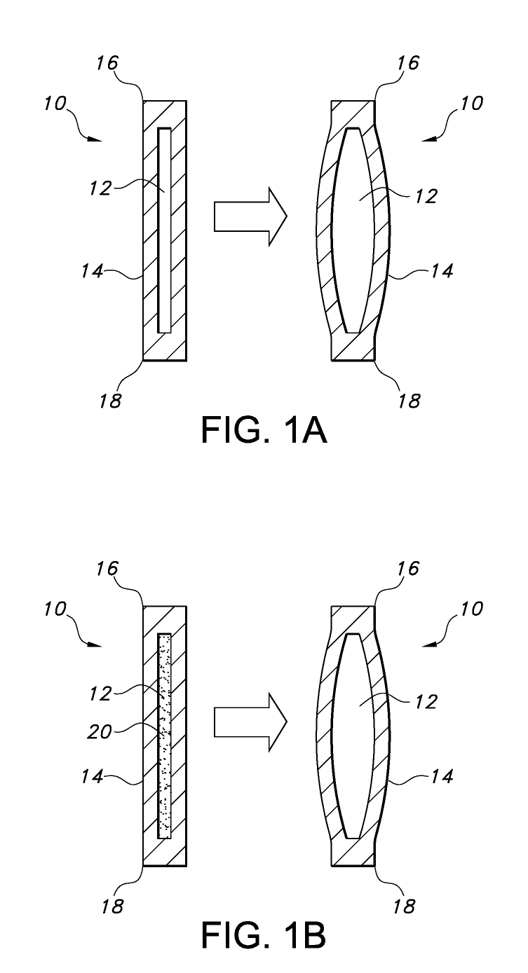

Referring to FIG. 1A, an expandable member 10 is shown before (left) and after (right) expansion. Referring to FIG. 1B, an expandable member 10 having a material 20 in the inner void 12 is depicted. The expandable member 10 includes a wall 14 that encloses an inner void 12. The arrow between expandable members 10 generally indicates an increase in temperature sufficient to expand the volume of gas in the inner void 12. The wall 12 is a shell that non-porous and impermeable to air, liquids, and the like.

In some embodiments, the wall 14 encloses the inner void 12 with a seal 16. In some embodiments, the seal 16 is a weld 18. In some embodiments, the wall 14 includes one or more welds 18. In some embodiments, the shell is sealed by pressing overlapping ends of the wall together (e.g. crimping the shell closed). In some embodiments, the shell is sealed with adhesives. In some embodiments the shell is sealed with fasteners (e.g. mechanical fasteners). Also, more than one of the aforementioned may be used in combination to seal the shell.

In some embodiments, the inner void takes up a portion of the volume of the expandable member. In some embodiments, the inner void is: at least about 5% by vol.; at least about 10% by vol.; at least about 15% by vol.; at least about 20% by vol.; at least about 25% by vol.; at least about 30% by vol.; at least about 35% by vol.; at least about 40% by vol.; at least about 45% by vol.; at least about 50% by vol.; at least about 55% by vol.; at least about 60% by vol.; at least about 65% by vol.; at least about 80% by vol.; at least about 85% by vol.; at least about 90% by vol.; at least about 95% by vol.; or at least about 98% by volume of the expandable member.

In some embodiments, the inner void is: not greater than about 5% by vol.; not greater than about 10% by vol.; not greater than about 15% by vol.; not greater than about 20% by vol.; not greater than about 25% by vol.; not greater than about 30% by vol.; not greater than about 35% by vol.; not greater than about 40% by vol.; not greater than about 45% by vol.; not greater than about 50% by vol.; not greater than about 55% by vol.; not greater than about 60% by vol.; not greater than about 65% by vol.; not greater than about 80% by vol.; not greater than about 85% by vol.; not greater than about 90% by vol.; not greater than about 95% by vol.; or not greater than about 98% by volume of the expandable member.

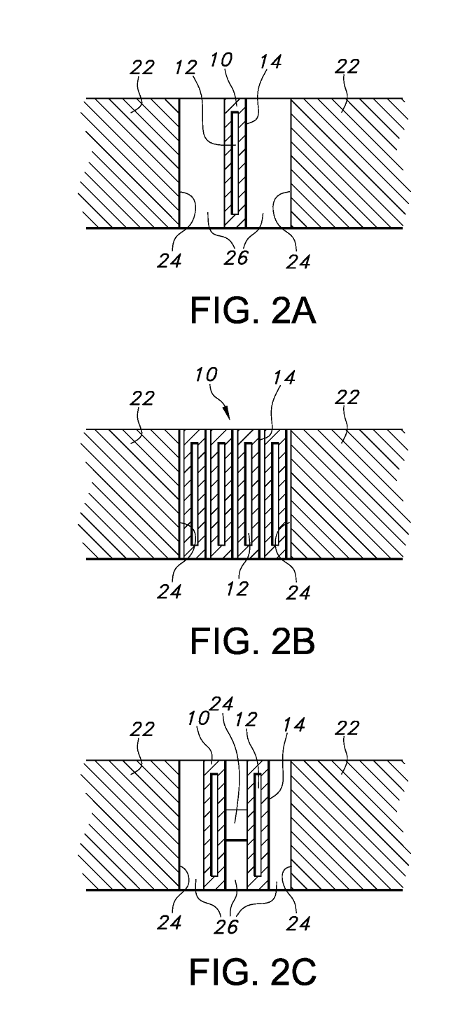

Referring to FIGS. 2A-2C, the expandable member 10 is attached to or adjacent to an outer end and/or an inner end 24 of one or more components 22. In some embodiments, the expandable member 10 is used with fillers 16 between the balloon sides (e.g. wall 14) and/or the ends 24 of the components 22. FIG. 2A depicts an expandable member 10 with fillers 26 on either face of the expandable member 10, which then contacts the inner side 24 of the components 22. FIG. 2B depicts a plurality of expandable members (e.g., four shown) that are adjacent to one another without filler materials. In FIG. 2B, the wall 14 of the expandable member 10 contacts the component 22 at its inner wall 24 directly. Referring to FIG. 2C, a plurality of expandable members 10 are in spaced relation to one another, with filler 26 between both the walls 14 of the balloons 10 and the inner wall 24 of the components. In FIG. 2C, and exemplary compression detector 28 is shown.

In operation, the expandable member 10 expands to exert a force (or pressure) onto at least one end of the component 22 such that the end(s) of the component 24 are pushed away from the expandable member 10 (e.g. in an axial direction). The component 22 is thus pushed or otherwise expands in a transverse direction (e.g. generally perpendicular to the direction of the force).

Without being bound by a particular mechanism or theory, from behavior approximated by the ideal gas law, the increase from ambient to elevated temperature (from 0° C. to 900° C.) works to increase the pressure of the gas inside the balloon. As a result, it is estimated that the pressure inside the balloon is at least about 4 atmospheres absolute, In some embodiments, inert gas is present inside the balloon and upon elevated temperature, the expansion pressure increases to about 4 ATM inside the void at 900° C. (e.g. no new gas is evolved). In some embodiments, air having ambient composition is present inside the balloon and upon temperature elevation; at least some oxygen (O₂) present in the air is removed from the system (e.g. rusts) so that the pressure inside the void at elevated temperature (e.g. 900° C.) is about 3.2 ATM. In some embodiments, the pressure inside the balloon (e.g. in the void) drops as the balloon expands, so the material expansion and creep should be selected a suitable expandable material to accommodate appropriate pressure increase inside the inner void. However, there may be reductions in this pressure due to loss of oxygen (e.g. to rust) and subsequent volume increase of the balloon (e.g. metal expansion).

In another embodiment, pressures exceeding 4 atmospheres are achievable by pressurizing the balloon in advance. In another embodiment, a small amount of material is sealed inside the balloon, where the material adds to the pressure as it heats up (e.g. by a phase change) to gas. For example MgCO₃ releases CO₂ gas near 350° C.

In some embodiments, a compression detector is employed in conjunction with the expandable member. The compression detector (e.g. sensor) includes a displacement gauge which detects the amount of compression of the system components. In some embodiments, the compression is detected by measuring the force that is imparted by the expandable member onto the end of the system components, and correlating it to the material properties of the expandable member in order to determine the amount of compression within the components.

### EXAMPLES

### Creep and Expansion in Component Materials

In order to determine the minimum amount of force necessary to get appropriate creep in the components, e.g. at elevated temperature conditions, experiments were conducted to determine the rate of creep over periods of time for sealed-down samples of steel at operating conditions with an external force applied. In operation, too little force may not reduce the gases between components, while too much force may cause the balloon and/or component, or compromise the resistance/springiness of the compression device, which would leave the component free to creep out of contact.

For low creep rates and high temperature, Harper-Dorn dislocation climb is believed to be a good model for secondary creep. The equation for this is:

$$\dot{ɛ} = {A}_{HD} \frac{G b}{k T} {D}_{0} {e}^{\frac{Q}{RT}} ( \frac{σ}{G} )$$

Under the experimental operating conditions, everything in the equation is fairly constant except strain rate and stress, and in the equation these are proportional.

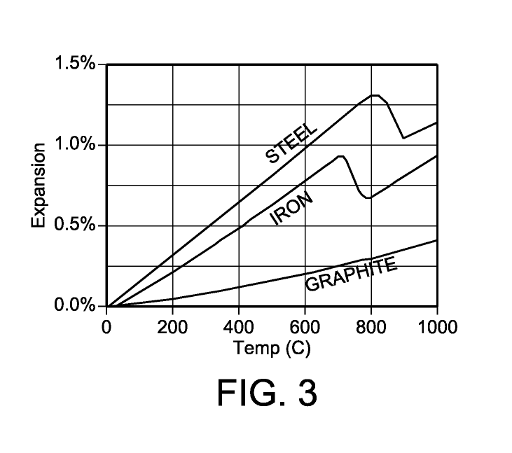

FIG. 3 depicts the different rates of thermal expansion of the expandable balloon and/or adjacent component materials. Referring to FIG. 3, the line for steel depicts the greatest expansion over increasing temperature, followed by iron. The lowest expansion is for graphite. In some embodiments, the component that the expandable balloon compresses upon is graphite, steel, iron, or combinations thereof. In some embodiments, the expandable balloon is steel, iron, graphite, or combinations thereof.

### EXAMPLE

### Bench Test of Expandable Member

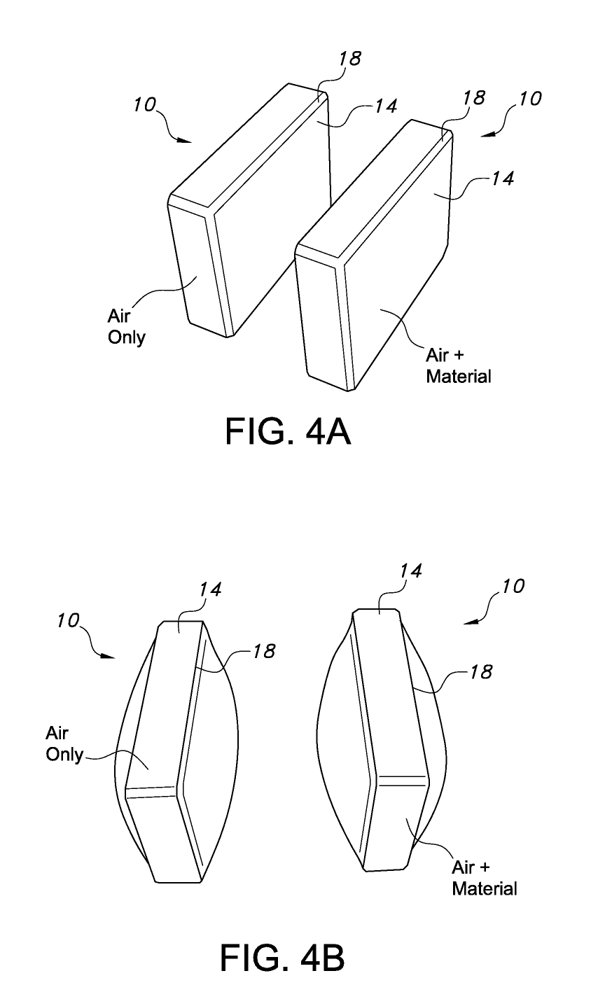

FIGS. 4A and 4B depict a perspective view of two expandable members (e.g. steel balloons), shown side by side. FIG. 4A depicts steel balloons that are sealed, but before expansion at an elevated temperature. The balloons of FIGS. 4A and 4B were welded together to seal the inner void. The expandable balloon on the left has air in its inner void, while the expandable balloon on the right includes air and a material that undergoes a phase change at elevated temperatures. These balloons of FIG. 4A have walls that are generally planar faces and ends, where the faces have a greater surface area than the ends. After expansion at an elevated temperature, the walls (generally planar faces) of the expandable balloons have expanded and pushed outward to a bowed position, while the ends remain generally unchanged. While these steel balloons are rectangular in shape, it should be noted that other shapes and/or profiles are possible.

### EXAMPLE

### Bench Test of Expandable Balloon

Referring to FIG. 5, two expandable members (steel balloons) were constructed, both with rounded edges as depicted in the cross-sectional view of FIG. 5. Both balloons had 1 gram of MgCO₃ which released CO₂ resulting in the rapid pressure increase between 350° C. and 450° C. Balloon 1 was constructed of ¼″ carbon steel walls, while Balloon 2 was constructed of ⅛″ stainless steel walls. The walls of each balloon were sealed with welds.

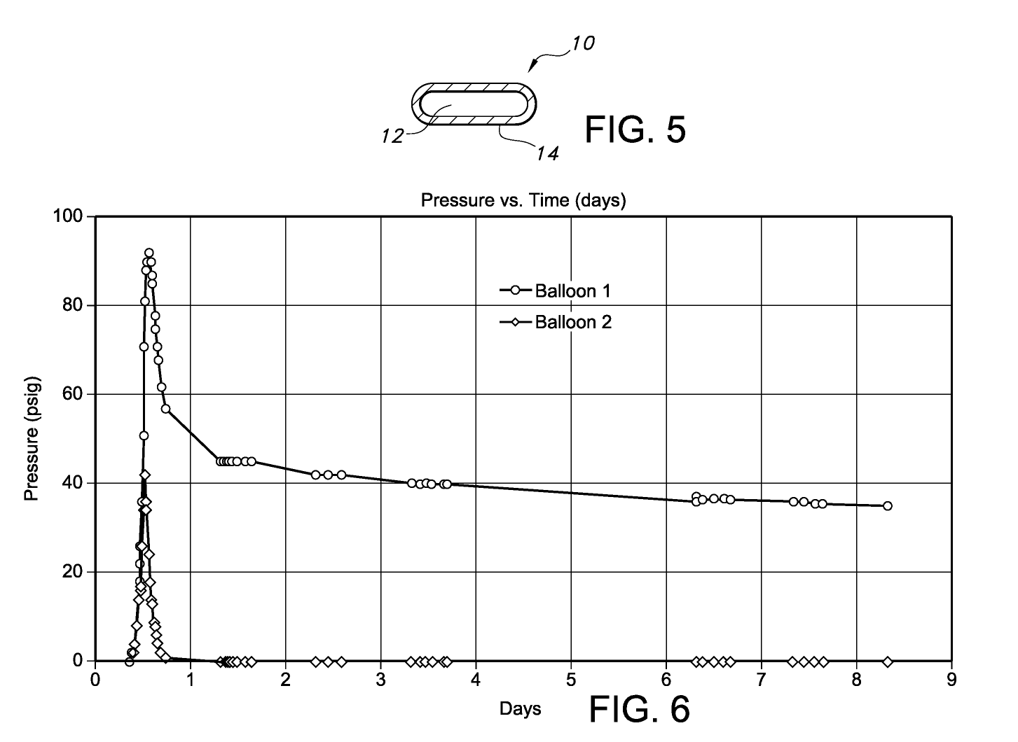

FIG. 6 is a chart that shows how the internal pressure of the balloons over a period of time (in days). As depicted in FIG. 6, is should be noted that Balloon 2 failed early on due to an inadequate weld, while Balloon 1 maintained a substantial pressure (e.g. well over 30 PSIG) throughout the trial period.

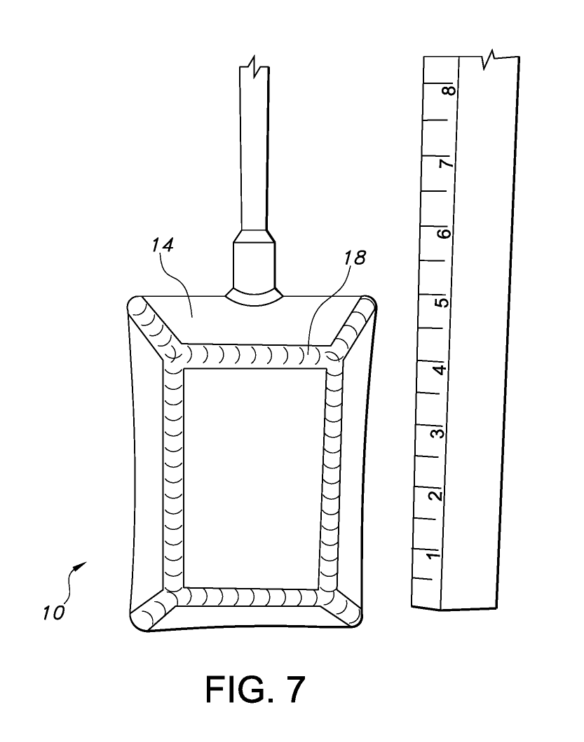

Referring to FIG. 7, another expandable member was constructed to undergo a 16-day experimental trial. The balloon had walls that were approximately ⅛ inch thick and the balloon was constructed of 304 stainless steel, as depicted in FIG. 7. The balloon faces are made of flat plate, while the rounded sides were cut from half sections of tube. The faces and edges (e.g. rounded edges) were attached by welding. This test balloon had nominal external dimensions of 5×3.5×1.25 inches. It contained 1 gram of MgCO₃, which contributed to the internal pressure by releasing CO₂ gas at the elevated temperature. The test balloon was partially constrained during the test, so that the “inflated” thickness of the balloon increased by only about ⅜ inch. It should be noted that the pressure tap located near the top of the test balloon was only for measuring the internal pressure of the test piece, and did not supply pressure to the test balloon. At the end of the trial, there were no leaks observed in the balloon.

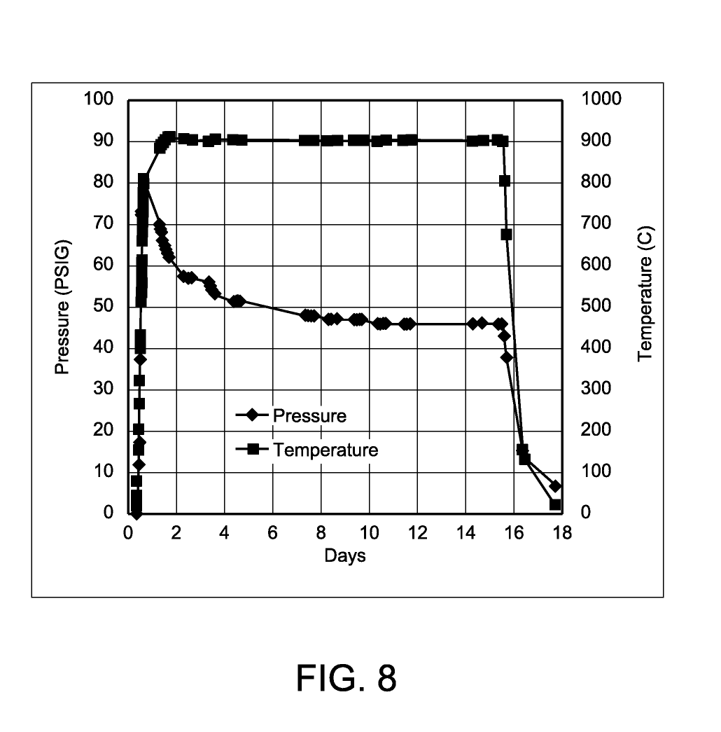

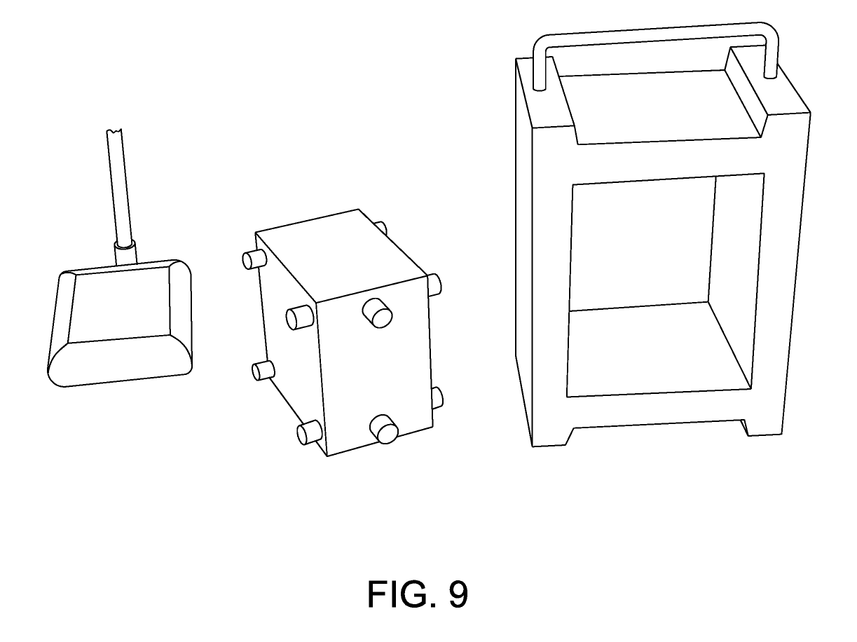

Referring to FIG. 8, the pressure and temperature are depicted over the days of the trial. Throughout the test (i.e. over a two-week period), the balloon maintained significant pressure at a temperature of approximately 900° C. Referring to FIG. 8, the chart plots the internal pressure of the balloon and temperature, as a function of time during the test (over a 19 day period).

Without being bound to a particular mechanism, the initial increase in pressure to a peak of 81 psig was believed to be driven by both the temperature (as per the ideal gas law) and release of CO₂ from the one gram of MgCO₃ powder inside the test piece, while the subsequent decrease in pressure was believed to be due to the volume expansion of the test piece, and possibly also due to the absorption of some gas species by the steel (perhaps nitrogen). It was observed that the pressure was extremely steady over the final week of the test (e.g. 7-˜16) at 46-47 psig (as depicted). It should be noted that the final drop in pressure (at the end of the test) was due to the drop in temperature (e.g. removal from heat), and not due to a leak. The test piece maintained a reduced positive pressure after the test, as would be expected under the ideal gas law.

### EXAMPLE

### Adjacent Object Deformation with Expandable Balloon Member

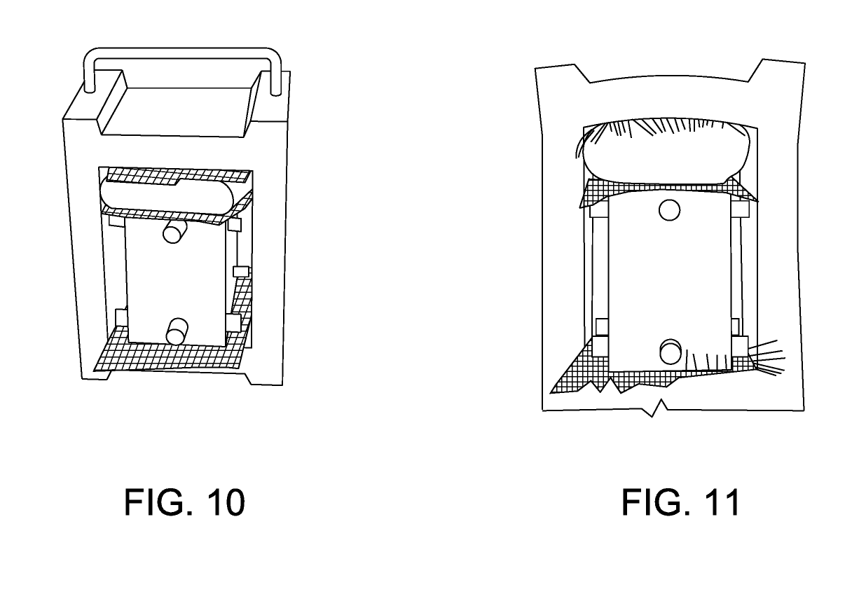

An experiment was performed to test whether an expandable member (steel balloon) was capable of enough compression to deform an adjacent object composed of a metal (e.g. metal bar/block). Referring to FIG. 9, this bench test used a steel frame (right) to constrain a steel balloon (left) and a short (4.5″ high) metal block (middle) with a cross section of 3×″4.5″. The assembled components before the test are depicted in FIG. 10, while the assembled components after the test are depicted in FIG. 11.

In order to read the pressure during the experiment, the balloon was fitted with a tube leading to a pressure gauge. In some embodiments, in a system at operating at elevated temperature (e.g. above 100° C.) this pressure gauge is omitted. The balloon contained 4 grams of MgCO₃, which was believed to decompose and release CO₂ gas (near 350° C.) as the configuration heated up to a temperature of approximately 900° C. The resulting CO₂ which is generated inside the balloon in turn pressurized the balloon, which, in combination with the elevated temperature conditions, resulting in the balloon's walls deforming/bowing outward and imparting pressure (compressing) to the adjacent objects (e.g. the metal block and the metal frame), FIG. 10 depicts the bar and balloon restraining frame, with the bar and balloon inserted into the frame.

Thermocouples were placed near the inside top and bottom of the frame, Graphite cloth was used between the balloon-to-frame and metal block-to-balloon contact points to prevent steel pieces from touching and welding together at temperature. The configuration was surrounded by packing coke and an argon purge, to prevent oxidation of the carbon steel frame and metal block (adjacent objects). This approach of using packing coke under argon atmosphere was found successful in preventing scaling of the carbon steel parts. The balloon was constructed of 304 stainless steel plate and 304L stainless steel tube, both nominally 0.125″ thick. The balloon's external dimensions were 4″×5,5″×1,25″,

The metal block was fitted with stainless steel pins for measuring the vertical deformation. Referring to FIG. 11, while the vertical compression of the bar is not apparent to the naked eye, the bending stresses developed in the restraining frame were high enough to cause visible deformation.

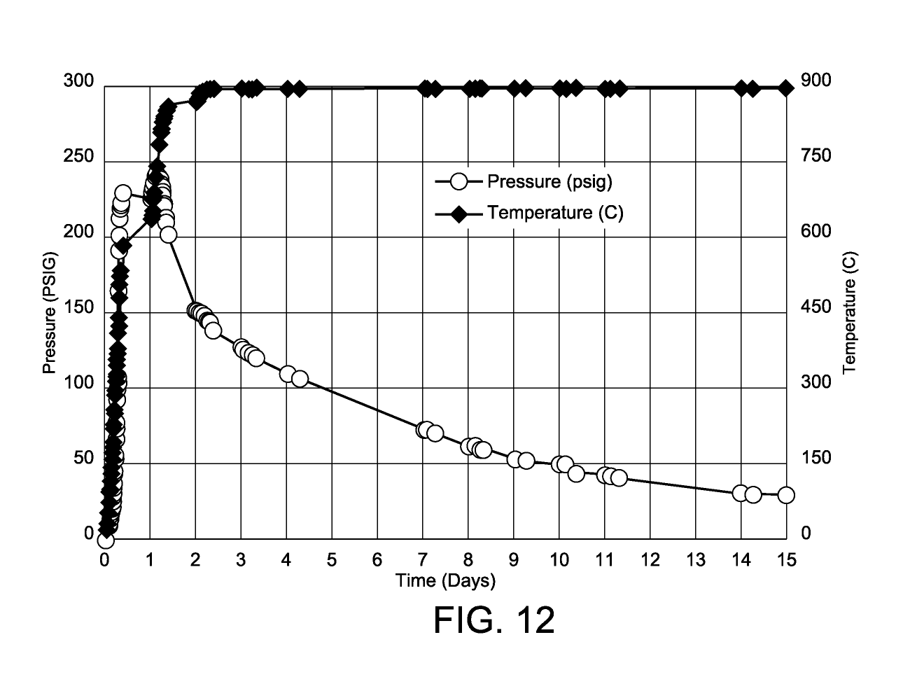

FIG. 12 depicts the average temperature and balloon pressure over the course of the test (depicted as a function of time, in days). Referring to FIG. 12, the temperature was brought up to 600° C. during the first day and then up to 900° C. on the second day, where it stayed for two weeks. Referring to FIG. 12, the pressure peaked near 250 psig, then decreased rapidly (at first), followed by a more gradual decrease in pressure. By the end of the test, the pressure was at about 30 psig. Without being bound to a particular mechanism or theory, it was believed that some pressure was lost inside of the balloon due to surface reactions between the CO₂ generated and the inner steel surface of the balloon.

Measurement of the inside and outside pin spacing as well as measurement of the full bar height showed a total compressive strain of about 0.14% in a longitudinal direction over the course of the test, as depicted in Table 1, below. This would correspond to a fattening across the width (transverse direction) of about 0.07% (which is about half of the strain in the longitudinal direction). Although deformation of the frame by the balloon was confirmed through visually inspected/observation (depicted in the figure), no measurements of the deformation in the frame was made to quantify the resulting strain.

TABLE 1
Measurements for total height change and change in average pin position give
total strain during the bench test. Pins were numbered in six vertical pairs.

Full Bar Height at Corners

| | 1-2 Corner | 3-4 Corner | 4-5 Corner | 6-1 Corner |
|---|---|---|---|---|
| Before | 4.634 | 4.608 | 4.596 | 4.623 |
| After | 4.6305 | 4.598 | 4.586 | 4.619 |
| Strain | −0.076% | −0.217% | −0.218% | −0.087% |

| | Pins | | | | | |
|---|---|---|---|---|---|---|
| | Pin 1-1 | Pin 2-2 | Pin 3-3 | Pin 4-4 | Pin 5-5 | Pin 6-6 |
| Outside Before Test | 4.0007 | 3.9998 | 4.0002 | 4.0003 | 3.9996 | 4.0000 |
| Inside Before Test | 3.0030 | 3.0025 | 3.0030 | 3.0040 | 3.0035 | 3.0030 |
| Outside After Test | 3.9985 | 3.9985 | 3.9960 | 3.9980 | 3.9920 | 3.9950 |
| Inside After Test | 3.0020 | 2.9980 | 2.9970 | 3.0000 | 2.9930 | 2.9960 |
| Strain | −0.046% | −0.083% | −0.146% | −0.090% | −0.258% | −0.171% |

Average of all Strains −0.14%

Referring to Table 1, the measurements taken across the width of the bar showed fattening (negative strain values refer to a reduction in size in a longitudinal direction, thus an increase in size in a transverse direction).

By extrapolating these results to a larger bar/block (e.g. about 4.25″ wide) in an operating system at elevated temperatures (e.g. about 900° C.), the strain is expected to correspond to a deformation of the bar in a transverse direction (bar “fattening”) of roughly 0.003. This was only about half of the expected 0.07%. Without being bound to a particular mechanism or theory, this may be attributed to “end effects” which refers to the changes occurring at one end of the bar and/or the limited number of measurements,

Therefore, while more deformation (from pressure being maintained longer) would result in a greater increase in contact between components in a system, the amount of deformation achieved with this configuration is believed to be sufficient to significantly reduce gaps between components (e.g. increase contact).

Further, without being bound by any mechanism or theory, the Harper-Dorn dislocation climb suggests that creep rate at temperature is proportional to compressive stress. Given the aforementioned, by integrating the pressure history and incorporating the measured creep, the relationship for the creep rate is as follows:

$$\dot{ɛ} = \frac{- 1.4 \times {10}^{- 6}}{psig day} \times σ$$

It is estimated that this structure, at prolonged elevated temperature conditions, would cause significant permanent deformation of a component, i.e. to prevent, reduce, and/or eliminate a gap between the components in a system.

In one or more aspect of the present disclosure, the expandable member(s) are utilized in conjunction with systems that operate at elevated temperatures (e.g, above at least about 100° C., 200° C., 300° C., 400° C., 500° C., 600° C., 700° C., 800° C., 900° C., or 1000° C.). In one or more embodiments, the expandable member is present in a system and acts upon one or more components (adjacent objects) in the system to compress those components in a direction (e.g. with an longitudinal/axial force such that the objects). In one or more embodiments, the system is a closed system during operation, such that the expandable member forces components into place (i.e. while the system is off-limits to other types of equipment or user adjustment due to the elevated temperatures in which the system operates).

While various embodiments of the instant disclosure have been described in detail, it is apparent that modifications and adaptations of those embodiments will occur to those skilled in the art. However, it is to be expressly understood that such modifications and adaptations are within the spirit and scope of the instant disclosure.

1. What is claimed is: An apparatus, comprising:
a metallic body having at least one sidewall, wherein the sidewall encloses a void, and an expandable material retained within the void and encased by the sidewall;
wherein the void comprises a first volume at a first temperature; and
wherein, at a second temperature of at least about 500° C., the expandable material expands such that the void comprises a second volume, wherein the second volume is greater than the first volume,
wherein, via the expansion of the expandable materials, the at least one sidewall exerts a pressure of at least about 150 psig.

2. The apparatus of claim 1, wherein the metallic body is sealed.

3. The apparatus of claim 2, wherein the metallic body is sealed by a sealant selected from the group consisting of: mechanical fasteners, bolts, welds, rivets, adhesives, and combinations thereof.

4. The apparatus of claim 1, wherein the expandable material comprises a gas; an inert gas, a phase change material, and combinations thereof.

5. The apparatus of claim 1, wherein the gas comprises an inert gas, oxygen, carbon dioxide, nitrogen, argon, or combinations thereof.

6. The apparatus of claim 1, wherein the void further comprises a filler material which does not contribute to the expansion.

7. The apparatus of claim 6 wherein the filler material is selected from the group consisting of: ceramic materials, aggregate, tabular alumina, refractory materials, rocks, graphite, and combinations thereof.

8. The apparatus of claim 6 wherein the filler material comprises at least about 50% of first volume the void.

9. The apparatus of claim 1, wherein the sidewall is not greater than about one inch thick.

10. The apparatus of claim 1, wherein the void is centrally located in the metallic body.

11. The apparatus of claim 1, wherein the cross sectional area ratio of the sidewall to void is about 1:10.

12. The apparatus of claim 1, wherein the metallic body comprises two sidewalls having opposing planar faces and a rounded perimetrical edge connecting the two faces.

13. The apparatus of claim 1, wherein the void is pressurized at a first temperature of not greater than about 100 psig.

14. The apparatus of claim 1, wherein the metallic body comprises an internal pressure of at least about 1.5 ATM at the second temperature.

15. A method, comprising:
increasing the temperature of a metallic body from a first temperature to a second temperature of at least about 500° C., wherein the metallic body comprises: at least one sidewall, wherein the sidewall encloses a central region having an expandable material retained therein via the sidewall;
concomitant with the increasing temperature step, increasing the volume of the central region via the expansion of the expandable material at the second temperature;
exerting, via the sidewall of the metallic body, a pressure of at least about 100 psig onto an adjacent object, wherein the adjacent object is in communication with the sidewall.

16. The method of claim 15, wherein the method further comprises moving the object first position to a second position.

17. The method of claim 15, wherein the increasing the temperature step further comprises heating the adjacent object.

18. The method of claim 17, wherein the method further comprises compressively straining the adjacent object.

19. A method, comprising:
forming at least one sidewall around an inner void to provide a metallic body having an opening;
inserting an expandable material into the void via the opening (e.g. pre-pressurized void with gas);
closing the metallic body, thus completely enclosing the void having an expandable material therein.
